(19) United States
(12) Patent Application Publication
(10) Pub. No.: US 2003/0070112 A1
(43) Pub. Date: Apr. 10, 2003

(54) Stored data recovery system

(76) Inventor: Lila York, San Antonio, TX (US)

Correspondence Address: Alan R. Thiele, JENKENS & GILCHRIST, P.C., Suite 3200, 1445 Ross Avenue, Dallas, TX, 75202-2799, US

(21) Appl. No.: 10/266,334

(22) Filed: Oct. 8, 2002

Related U.S. Application Data
(60) Provisional application No. 60/327,695, filed on Oct. 8, 2001.

(51) Int. Cl. H02H 3/05

(52) U.S. Cl. 714/5

(57) ABSTRACT

Disclosed is a system and a method for recovery of inaccessible data on flash data storage devices. The method comprises the steps of accessing the data on the flash data storage media, and enabling the technician to diagnose and rectify the data loss.

### TECHNICAL FIELD

The present invention relates, in general, to the recovery of information from devices including flash data storage memories and/or flash data storage systems. In particular, the present invention relates to the recovery of stored information which is inaccessible using the normal operating environment of a device including a flash data storage system. The present invention also relates to a method for allowing diagnosis and rectification of such data loss.

### BACKGROUND

The true value of a computing system to a user is not limited to the actual cost of the hardware and software components that make up the system, but the true value of a computing system also includes the value of the data represented and used by the hardware and software components of the computing system. Indeed, it is quite common that the accounting data, intellectual property, design and manufacturing information, and/or other records which are stored on computing systems in both personal and business use are ultimately of a value which far exceeds the value of the hardware and software components.

Flash data storage systems or memories are used in a variety of systems where the data being used by a device is retained once the power to operate the device is turned off.

Loss of the ability to access data retained in flash data storage systems can occur, often as a result of a system failure, a battery failure, the execution of format or deletion steps, corruption caused by hardware or software malfunction, operator error, electrical events, acts of sabotage, or simple mechanical failures. In many instances, although the stored data is not readily accessible by procedures used in the normal operating environment, the data itself still exists on the flash data storage media, and the stored data can actually be rendered accessible or retrieved by manipulating the data structures which represent the file system(s). Such manipulation of the data structures in flash data storage systems is most reliably performed by trained technicians equipped with highly specialized software tools.

It is occasionally the case that the inaccessibility of data can be the cause of significant cost and/or lost business, sometimes to a catastrophic degree. While some forms of information stored in flash data storage media or cards may be candidates for re-creation, the cost of this data re-creation may range from trivial to prohibitive. Additionally, data recreation can consume large quantities of time, during which time some key aspects of a business may be necessarily suspended or hampered due to dependence upon the data contained in the flash storage media which has become inaccessible. There also exist categories of data which are generally acquired in real-time, which cannot be re-created, and which can therefore be considered as irreplaceable.

Traditional data storage redundancy mechanisms, such as off-line backup, tend to provide relief for some flash data storage system loss situations. Restoration of stored data from off-line backup can, however, be time-consuming and may provide data which has aged significantly with respect to the data which could potentially be available through data recovery procedures. Therefore, even data losses which are theoretically restorable from off-line data storage backup may be considered as potential data recovery candidates. Unfortunately, the circumstances leading to data loss can frequently also cause the normal file structure of a flash data storage system to become unstable or unusable. There is therefore a need in the data recovery field for a system and method which will reliably allow the recovery of data from flash data storage systems. Accordingly, there is also a particular need for a method of providing data recovery capabilities from flash data storage media when the normal file structure is not loadable or dependable.

### SUMMARY

The present invention solves the foregoing data recovery problems and provides a method and apparatus for data recovery from flash data storage systems which is inaccessible by the normal operating environment and to a method for diagnosis and rectification of data loss. The present invention also provides a means to enable flash data recovery operations, including, but not limited to, those situations where the normal file system is not accessible.

The invention relates to a method of data recovery including the steps of:

a) establishing a data link via hardware from a flash data storage system requiring recovery of data to a data recovery computer operated by a technician;

b) enabling the technician to interact with the flash data storage system while having access to all data recovery programs which are resident at the flash data storage system; and

c) enabling the technician to diagnose and rectify the data loss of the flash data storage system.

The principles of the present invention are achieved by implementing a stored data recovery system which has sufficient functionality to allow data exchange via specialized hardware connected to the flash data storage system. The technician is further equipped with specialized software which allows communications with the flash data storage system via the hardware layer. Once the device under recovery and the computer are in communication, data recovery operations on the flash data storage system can proceed under the complete control of the technician.

### DESCRIPTION OF THE DRAWING FIGURES

For a better understanding of the invention, its advantages, and the objects obtained by its use, reference should be made to the accompanying drawings and the following descriptive matter in which there is illustrated and described both preferred and alternate embodiments of the invention.

In the drawings, corresponding reference numerals generally indicate corresponding parts throughout the several drawing figures.

FIG. 1A is a schematic diagram of a removable memory card being used with a digital still camera;

FIG. 1B is a schematic of a removable memory card being used with a digital audio recorder;

FIG. 1C is a schematic of a removable memory card being used in other types of devices using a flash card data storage system;

FIG. 1D is a schematic of a removable memory card being used with a laptop computer or a desktop personal computer by connection through a PC card (PCMCIA) interface or other memory card adapter installed on the computer;

FIG. 2 is a block diagram of an embodiment of an apparatus in accordance with the principles of the present invention;

FIG. 3 is a flow diagram of a portion of the application of the present invention which causes the execution of the Data Recovery Diagnostic Application and subsequent recovery to the original Flash Memory card;

FIG. 4 is a flow diagram of a portion of the application of the present invention in which all sectors of the Flash Memory device are imaged onto a FlashBack workstation, the execution of the Data Recovery Diagnostic application and subsequent recovery is performed, and the recovered data is placed on a separate device.

### DESCRIPTION OF THE EMBODIMENTS

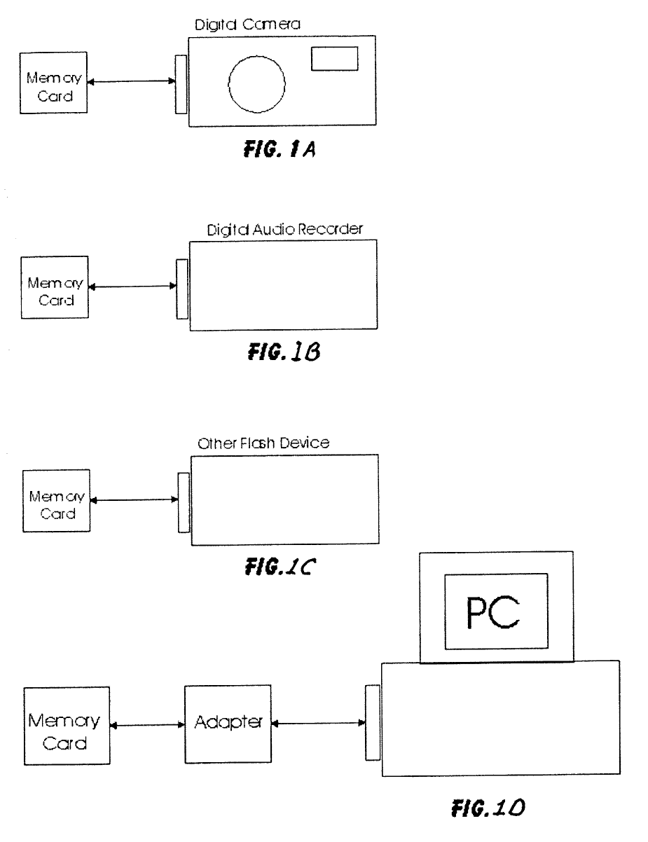

FIGS. 1A-1C illustrate the typical applications and operating environment in which the flash data storage media is a removable memory card. Those of ordinary skill in the art will understand that some flash data storage media are contained within the supported device and are not removable.

As shown in FIG. 1A the connection between the removable memory card and the digital still camera is by means of either a PCMCIA slot or one of the smaller form-factor card interfaces.

As shown in FIG. 1B the digital audio recorder can be a voice recorder such as a dictation machine, or it can be a sophisticated system for the recording and playback of music.

As shown in FIG. 1C, a removable memory card may be used with a variety of other devices including but not limited to notebook computers, palmtop computers, personal digital assistants, cellular telephones, medical equipment, photo printers, data capture devices, and synthesizers.

As shown in FIG. 1D, a removable memory card may be used with either a portable personal computer (notebook or laptop) or a non-portable desktop personal computer by connection through a PC card (PCMCIA) interface or other memory card adapter.

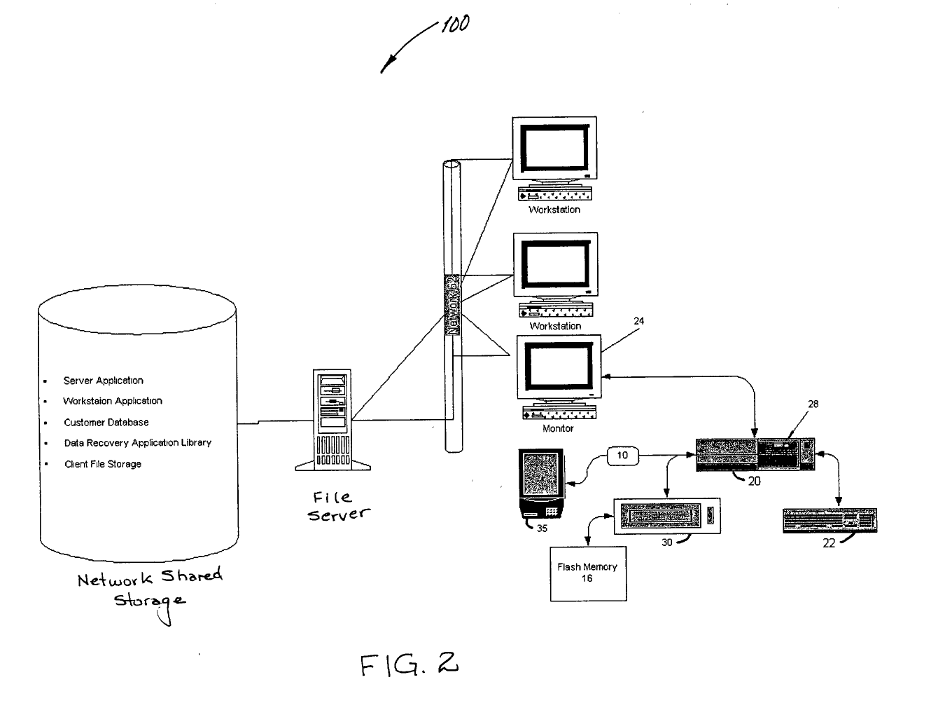

Illustrated in FIG. 2 is a block diagram of an embodiment of the system 100 of the present invention. The system 100 is built around a data recovery computer (flashback workstation) system 20, for which a data recovery procedure software program is needed. Computer system 20 is illustrated as having a central processing unit (CPU) (typically arranged on a common system board), a local input device 22, a local display 24, a local storage device and a removable media storage system 28, and specialized hardware for accessing the information contained on a flash data storage card 16.

In addition, the FlashBack Workstation 20 is shown as being connected to a flash card adapter 30 for access to the information of a flash data storage card 16. For example, the local communications hardware interface 30 may be an adapter card 30, a serial cable, a USB device, a network card, or some other interface. The flash data storage card 16 may include any flash ram compatible card or other type of flash card data storage system commonly sold by various vendors such as SimpleTech, Kingston Technology Company, Matsushita, Panasonic, etc. In particular, the flash data storage system might have varying geometry, 12 or 16 bit FAT, or other proprietary features along with an amount of random access memory (RAM). The flash data storage system might include any one of a variety of commercially available flash data storage systems, including ATA, Memory Stick, CompactFlash™, Multi-media, Secure Digital etc. The interface between the flashback workstation 20 and the flash data storage card 16 might be internal or external and might take on varying technologies.

The local communications hardware interface 10 might be any conventional type of connection device such as a USB or serial port, infra-red connection, ISDN or wireless modem, or may alternatively be accessed through a conventional local area network, wide area network or Internet (LAN/WAN/InterNet) connectivity hardware, such as a network card, etc. A device including a flash data storage system 35 may be connected to the flashback work station 20 through the local communications hardware interface 10.

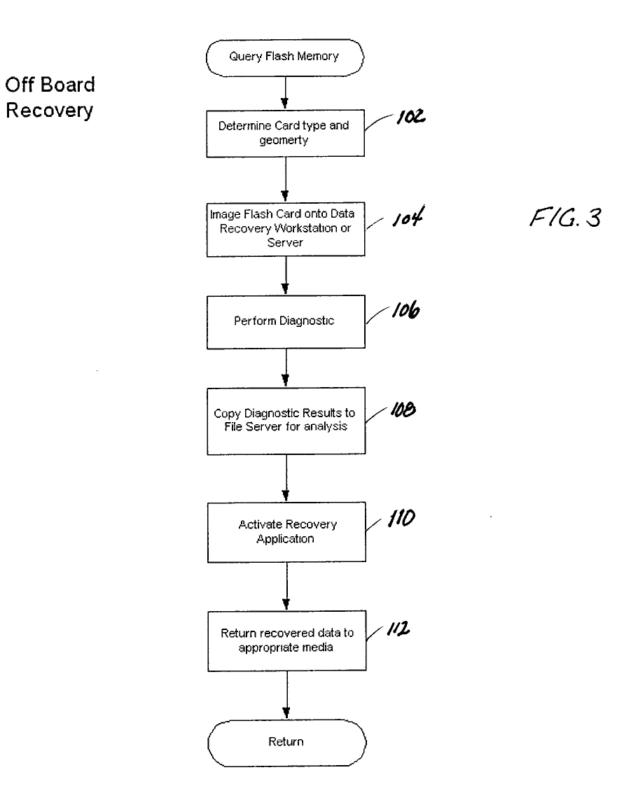

FIG. 3 is a flow diagram of that portion of the Data Recovery procedure of the present invention which facilitates performance of a data recovery diagnostic. An initial hardware query 102 is made for the determination of PC Card type and memory size, geometry, chip type, firmware revision and other programmable searches as necessary for type of card. The flash card is then imaged onto a data recovery workstation or server 104. A diagnostic is then performed 106 based on the information generated in the query and results are logged onto the file server for analysis 108. A check is made to see if the current recovery application exists on the flashback workstation 20. If a valid copy of this application does not exist or there is no appropriate version of the application, an appropriate version of the recovery application is downloaded to the flashback workstation 20. Subsequently, or, if the appropriate recovery application was determined to exist, the recovery application is activated 110. The recovered data is then copied to the file server and loaded back onto the original media 112.

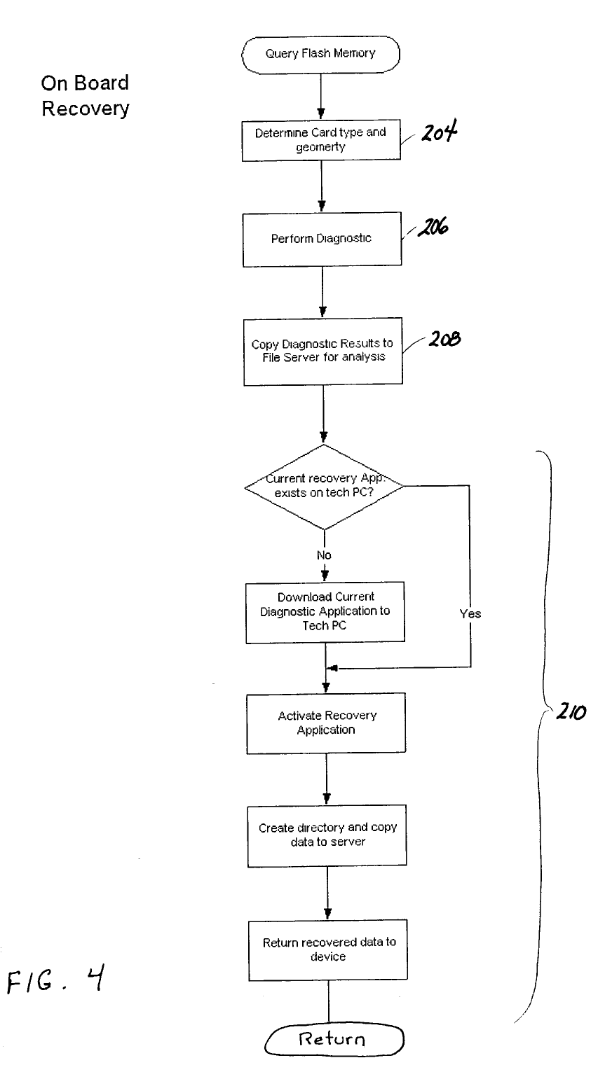

FIG. 4 is a flow diagram of that portion of the Data Recovery procedure which facilitates performance of the Data Recovery Diagnostic and recovery. An initial hardware query is made for the Determination of PC Card type and memory size, geometry, chip type, firmware revision, and other programmable searches as necessary for type of card 204.

All physical sectors of the flash data device are then loaded onto a separate directory of the file server (see FIG. 2) or technical workstation. A diagnostic is then performed 206 based on the information generated in the query, and results are logged onto the file server for analysis 208.

Appropriate recovery 210 is performed, and the recovered data is returned on separate media such as another Flash Device, CD-Rom or other appropriate media. The recovered data can also be returned to the client through email, FTP download, or other transfer method.

Operation

The basic method for recovering data from a flash data storage system includes generally the steps of loading flash data storage media into a device using a flash data storage system. The device is connected to a technical workstation. Loaded into the memory of the technical workstation are all the physical sectors of the flash data media. Alternatively, the flash data storage system is remotely controlled through hardware/software. Once this step is completed, the data storage on the flash data storage media can be diagnosed and rectified through operation of the data recovery portion of the technical workstation.

In addition to the basic method disclosed in the foregoing paragraph, the step of querying a flash data storage system for information through operation of a data recovery program by the technical workstation prior to loading sectors onto the data recovery portion of the technical workstation may be included. Such step includes querying the flash data storage system to determine at least one of the following parameters: the PC card type, the memory size, the PC card geometry, the chip type, the revision of the firmware, and the type of card.

The step of querying the flash data storage system for operation may include identifying information through operation of a data recovery program by the technical workstation prior to loading all physical sectors of the flash data media into the memory of the technical workstation.

The step of querying the flash data storage system for identifying information may also include the step of checking socket status for write protection and the status of the backup battery on the flash data storage system.

Further, step of querying the flash data storage system for information may also include monitoring the flash data storage medium containing the data recovery application programs.

The basic method for recovering data from a flash data storage system may also include the step of executing a data recovery application program on the flash data storage system. If the step of executing a data recovery application program on the flash data storage system is included, such step may include the execution of a data recovery application program which includes the step of computing a CRC check sum over an entire PC card or a section thereof.

The basic method for recovering data from a flash data storage system may also include the step of executing a data recovery diagnostic program on the flash data storage system. If such diagnostic step is performed, this step may also include generating DOS-formats for SRAM and ATA cards.

The basic method for recovering data from a flash data storage system may also include the step of downloading data to be recovered from the flash data storage system to the technical workstation.

The basic system for recovering data from a flash data storage system may also include the step of logging or write activity to be performed on a sector of the flash data storage media to a file on the technical workstation. If the write activity is logged, this may also include the step of providing each entry within the file with an identifier which identifies the sector and the local storage device as well as the latest data which was written to that sector.

System

The basic system of the present invention is suitable for use with a flash data storage system selected from a group including CompactFlash™, ATA Type I, II, III, or IV, digital film card, SmartMedia™, Memory Stick™, Multi-media Card (MMC), Secure Digital Card (SD), or other similar flash data storage system. Also included is a computer which accesses or controls the flash data storage system so that the data on the flash data storage media can be diagnosed and rectified.

Also included in the basic system is a technical workstation which includes a second data storage media for storing a data recovery application program.

The basic system may also include a communications channel over which communications are established between the flash data storage system and the technical workstation. This communications channel may use one of a group including a PCMCIA adapter, floppy type adapter, local area network, wide area network, internet and proprietary adapter which are suited to the flash storage device.

In addition, the flash data storage system may be operable from the data recovery computer so as to recover data from the flash storage media.

Further, the flash data storage device is operable from the data recovery computer so as to diagnose a data recovery situation on the flash data storage media.

Those of ordinary skill in the art will understand that according to the disclosed system data may be recovered by establishing a link between the technical workstation and the flash data storage media through operation of a data recovery application by the technical workstation and controlling the flash data storage by the technical workstation. This allows the data on the storage media of the flash data storage system to be diagnosed and rectified through operation of the technical workstation. Accordingly, the data recovery system will allow for transferring all data which is marked for being changed to an archival facility before making the changes to the flash card data storage medium.

As previously described, the system will allow for logging or write activity to be performed on a sector of the local storage device or to a file on the flash card data storage media.

Those of ordinary skill in the art will understand that the invention disclosed herein will have a variety of applications, particularly with regard to establishing a chain of custody in forensic cases.

The foregoing advantages and features of novelty which characterize the invention are pointed out with additional particularity in the claims annexed hereto and forming a part hereof.

What is claimed is:

1. A method for recovering data from a flash data storage system, the method comprising the steps of:
loading flash data storage media into a device using a flash data storage system, said device being connected to a technical workstation;
loading all physical sectors of the flash data media into memory of the technical workstation or remotely controlling the flash data storage system through hardware/software;
whereupon data storage on the flash data storage media can be diagnosed and rectified through operation of the data recovery computer portion of the technical workstation.

2. The method as defined in claim 1, further including the step of querying a flash data storage system for information through operation of a data recovery program by the technical workstation prior to loading sectors onto the data recovery computer portion of the technical workstation.

3. The method as defined in claim 2 wherein said step of querying said flash data storage system includes determining at least one of: the PC card type, the memory size, PC card geometry, chip type, firmware revision, and type of card.

4. The method as defined in claim 2, further including the step of querying the flash data storage system for identifying information through operation of a data recovery program by the technical workstation prior to loading all physical sectors of the flash data media into memory of the technical workstation.

5. The method as defined in claim 4 wherein the step of querying the flash data storage system for identifying information further includes the step of checking socket status for write protection and the status of the backup battery on the flash data storage system.

6. The method as defined in claim 2, wherein the step of identifying the flash data storage system includes monitoring the flash data storage medium containing the data recovery application programs.

7. The method as defined in claim 1 further including the step of executing a data recovery application program on the flash data storage system.

8. The method as defined in claim 7 wherein the step of executing a data recovery application program further includes the step of computing a CRC checksum over an entire PC card or section thereof.

9. The method as defined in claim 1, further including the step of executing a data recovery diagnostic program on the flash data storage system.

10. The method as defined in claim 9 wherein the step of executing a data recovery diagnostic program includes the step of generating DOS-Formats for SRAM and ATA cards.

11. The method as defined in claim 1, further including the step of downloading data to be recovered from the flash data storage system to said technical workstation.

12. The method as defined in claim 1, further including the step of logging all write activity, to be performed on a sector of the flash data storage media to a file on said technical workstation.

13. The method as defined in claim 12, further including the step of providing each entry within the file with an identifier which identifies the sector and the local storage device, as well as the latest data which was written to that sector.

14. A data recovery system for recovering inaccessible data from a flash data storage system, comprising:
a flash data storage system selected from a group including: CompactFlash, ATA Type I, II, III or IV, digital film card, SmartMedia, Memory Stick, Multimedia Card (MMC), Secure Digital Card (SD) or other similar flash device;
a data recovery system including a computer which computer accesses or controls the flash data storage system so that data on the flash data storage media of the flash data storage system can be diagnosed and rectified.

15. A data recovery system as defined in claim 14, further including a technical workstation which includes a second data storage media for storing data recovery application program means.

16. A data recovery system as defined in claim 14, further comprising a communications channel over which communications are established between the flash data storage system and the technical workstation, said communications channel using one of the group including a PCMCIA Adapter, Floppy type adapter, local area network, wide area network, Internet and proprietary adapter suited to the flash storage device.

17. A data recovery system as defined in claim 14, wherein the flash data storage system is operable from said data recovery computer so as to recover data from the flash data storage media.

18. A data recovery system as defined in claim 14, wherein a flash data storage device is operable from the data recovery computer so as to diagnose a data recovery situation on the flash data storage media.

19. A data recovery system for recovering inaccessible data from a flash data storage system to another flash data storage system, said data recovery system comprising:
a flash data storage system selected from a group including: CompactFlash, ATA Type I, II, III or IV, digital film card, Smart Media, Memory Stick, Multimedia Card (MMC), Secure Digital Card (SD) or other similar flash device;
a computer which accesses or controls the flash data storage system so that data on the flash data storage media can be diagnosed and rectified.

20. The data recovery system as defined in claim 19 further including: a communication channel over which communications are established between the flash data storage system and another flash data storage system, said communications channel using one of the group including an PCMCIA Adapter, a Floppy type adapter, local area network, wide area network, Internet, and proprietary adapter suited to the flash storage system.

21. A method for recovering data from a flash data storage system, the method comprising the steps of:
establishing a data link between a technical workstation and a flash data storage media through operation of a data recovery application program by a technical workstation; and
controlling flash data storage by a technical workstation;
whereupon data on the storage media of the flash data storage system can be diagnosed and rectified through operation of said technical workstation.

22. A data recovery system as defined in claim 21, further including means for transferring all data, which is marked for being changed to an archival facility before making the changes to the flash card data storage media.

23. A data recovery system as defined in claim 21, further including means for logging all write activity, to be performed on a sector of a local storage device, or to a file on the flash card data storage media.

24. A data recovery system as defined in claim 21, wherein each entry within the file contains an identifier, said identifier identifying the sector and the local storage device, as well as the latest data which was written to that sector.

25. A data recovery system as defined in claim 21, further including means to select data recovery events during a data recovery process.

26. A method of data recovery comprising the steps of:
establishing a communications link between a flash data storage system requiring recovery of data and a data recovery computer;
enabling interaction between said flash storage system and said data recovery computer; diagnosing said flash data storage system;
downloading a data recovery application program from said data recovery computer to said flash data storage system; and
recovering data on the flash storage system.
